(19) United States
(12) Patent Application Publication
(10) Pub. No.: US 2012/0132116 A1
(43) Pub. Date: May 31, 2012

(54) GROUND OPENER ASSEMBLY WITH GUIDING TRACK FOR DEPTH CONTROL

(75) Inventors: Patrick M. Beaujot, Langbank (CA); Barry K. Melanson, Kennedy (CA); David R. Duke, Langbank (CA); Bruce W. Wilton, Langbank (CA)

(73) Assignee: ONE PASS IMPLEMENTS INC., Langbank (CA)

(21) Appl. No.: 13/305,644

(22) Filed: Nov. 28, 2011

Related U.S. Application Data
(60) Provisional application No. 61/418,273, filed on Nov. 30, 2010.

(51) Int. Cl. A01C 7/00; A01C 13/00; A01C 5/06

(52) U.S. Cl. 111/163; 111/170; 111/156

(57) ABSTRACT

A ground opener assembly mountable to a frame is provided, comprising a guiding member having a track mountable to the frame; a first trailing arm having a front end and a rear end, the front end of the first trailing arm operably associated with the guiding member so that the first trailing arm can travel along the track; a second trailing arm having a front end and a rear end, the front end of the second trailing arm pivotally attached to the frame; a rear link having a proximal end and a distal end, the rear end of the first trailing arm fixedly attached to the proximal end of the rear link and the rear end of the second trailing arm pivotally attached to the proximal end; at least one dispensing implement and a ground compressing member mounted to the rear link; and a bias device operative to exert a downward bias force on the rear link, the at least one ground opening tool and the ground compressing member.

The present application claims priority to U.S. Provisional Patent Application No. 61/418,273, filed Nov. 30, 2010 and incorporated by reference for all purposes.

### FIELD OF THE INVENTION

The present invention relates to a ground opener assembly for a seeding or planting unit and more particularly to a ground opener assembly having a guiding track for depth control to maintain the depth of the ground opener(s) so that particulate material placement, such as seeds and fertilizer, is constant.

### BACKGROUND OF THE INVENTION

It is desirable when seeding/planting a field that particulate materials, such as seed, fertilizer, inoculants and other seed treatments, are applied to the field at a constant depth to ensure uniform plant emergence. There exists a variety of ground opener assemblies, both single opener assemblies and dual opener assemblies, which are designed to attempt to control the depth of the furrows as constant as possible.

For example, there exists a number of trailing arm ground opener assemblies that that attempt to control furrow depth. One such trailing arm ground opener assembly comprises a single long arm that is attached to the frame of the seeding or planting unit by a single pivot (see, for example, U.S. Pat. No. 5,396,851). Attached to the single long arm is at least one ground engaging opener and the depth of the at least one opener is controlled by a packer gauge wheel attached onto the end of the arm. However, in uneven terrain, the distance between the frame and the ground varies, resulting in the trailing arm moving up and down about its pivotal attachment to the frame such that the distance from the furrow opener attachment to the ground varies. Thus, the depth of the furrow will vary as will the placement of the particulate material.

There also exist trailing arm ground opener assemblies that are comprised of a pair of parallel arms, whereby each of the parallel upper and lower arms are pivotally attached to the frame of the seeding or planting unit via a front link (see, for example, U.S. Pat. No. 7,159,523). The furrow opener and rear packer wheel are fixed to a rear link on the parallel arms and the rear link is maintained in a constant horizontal and vertical orientation through the vertical range of motion without tilting forward or rearward to maintain a constant furrow depth. Thus, the parallel arm link allows for more consistent seeding/fertilizing in uneven terrain as compared to the single long arm. However, the parallel link presents its own problems, in particular, during transport of the furrow opener assemblies. With the parallel link opener assemblies, the opener assemblies fold into an inverted V-shape during transport and therefore take up more vertical space. This proves to be a problem when designing the various frame support members, which are attached to the main frame. Thus, in the vertical transport position, there may be frame clearance issues and ground clearance issues due to its geometry. Other disadvantages of the parallel arm linkage are that there are four wear points, i.e., the four pivot points, versus one pivot point with the single arm linkage.

There is a need for a trailing arm ground opener assembly that addresses some of the problems encountered with the prior art assemblies.

### SUMMARY OF THE INVENTION

In a first aspect, a ground opener assembly mountable to a frame is provided, comprising:
a guiding member having a track mountable to the frame;
a first trailing arm having a front end and a rear end, the front end of the first trailing arm operably associated with the guiding member so that the first trailing arm can travel along the track;
a second trailing arm having a front end and a rear end, the front end of the second trailing arm pivotally attached to the frame;
a rear link having a proximal end and a distal end, the rear end of the first trailing arm fixedly attached to the proximal end of the rear link and the rear end of the second trailing arm pivotally attached to the proximal end;
at least one dispensing implement and a ground compressing member mounted to the rear link; and
a bias device operative to exert a downward bias force on the rear link, the at least one ground opening tool and the ground compressing member.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic side view of one embodiment of a ground opener assembly of the present invention in operation on flat ground;

FIG. 2 is a schematic side view of the ground opener assembly embodiment of FIG. 1 in operation in a valley or gully;

FIG. 3 is a schematic side view of the ground opener assembly embodiment of FIG. 1 in operation over a hill or knoll;

FIG. 4 is a schematic side view of the ground opener assembly embodiment of FIG. 1 in maximum ground depth position;

FIG. 5a is a schematic side view of an embodiment of a ground opener assembly of the present invention in transport position showing frame and sub-frame;

FIG. 5b is a schematic side view of a prior art parallel arm ground opener assembly in transport position showing frame and sub-frame;

FIG. 6a is a perspective view of the right hand side of an embodiment of a ground opener assembly of the present invention;

FIG. 6b is a perspective view of the left hand side of the embodiment of a ground opener assembly shown in FIG. 6a;

FIG. 7a is a perspective view of the right hand side of another embodiment of a ground opener assembly of the present invention;

FIG. 7b is a perspective view of the dispensing implement of the ground opener assembly of FIG. 7a.

FIG. 8 is a perspective view of the right hand side of another embodiment of a ground opener assembly of the present invention.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

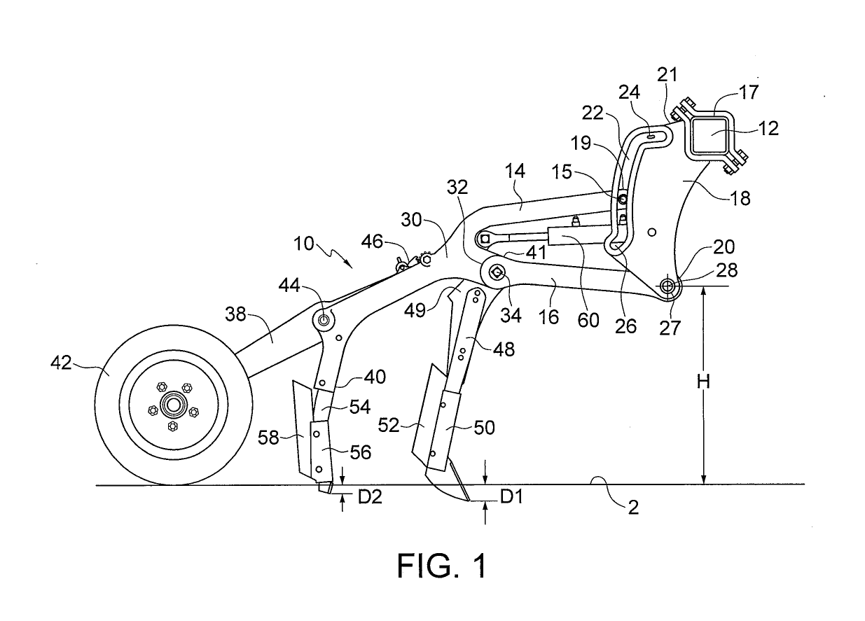

FIG. 1 is a schematic side view of an embodiment of a ground opening assembly of the present invention. In this embodiment, the ground opener assembly is a dual material dispensing ground opener assembly and is shown in FIG. 1 as operating in flat field conditions. Ground opener assembly 10 comprises a first trailing arm 14 and a second trailing arm 16, whereby the front ends of each arm, labeled 19 and 20, respectively, are associated with guiding member 18 as described in more detail below. Guiding member 18, which can be made from any number of materials such as steel, etc., is attached to frame 12 of a seeding or planting apparatus at or near its top end 21 by means of clamp 17 so that the top of guiding member 18 is essentially at the same height as frame 12. It is understood that other attaching means known in the art can also be used. Guiding member 18 comprises an elongated slot or groove, hereinafter referred to as track 22, which in one embodiment can be S-shaped having a top hook 24 and a bottom hook 26.

The front end 19 of first trailing arm 14 is attached to guiding member 18 by means such as bolt 15 or a roller bearing, so that the first trailing arm 14 can travel or follow the entire length of track 22 without significant fore or aft movement. Second trailing arm 16, on the other hand, is pivotally attached to frame 12, in this embodiment via its front end 20 attached to the guiding member 18 at or near the bottom end 27 of guiding member 18 by pivot 28. It is understood, however, that trailing arm 16 could also be pivotally attached to frame 12 by any other structural element that is attached to the frame.

Ground opener assembly 10 further comprises rear link 30, which in the embodiment shown in FIG. 1 is contiguous with first trailing arm 14 (i.e., formed as a single structural entity). It is understood, however, that first trailing arm 14 could also be a separate member that is fixedly attached to rear link 30. Rear link 30 comprises a proximal end 41 and a distal end 40. The rear end 32 of the second trailing arm 16 is pivotally attached to rear link 30 by pivot 34 at proximal end 41.

A packing assembly, comprising packer wheel arm 38 and a ground engaging or compressing member in the form of a wheel element, packer wheel 42, is attached to rear link 30 by pivot 44 so that the packer wheel 42 depth can be set using packer wheel depth controller 46, which controller will be described in more detail below. It will be appreciated, however, that a person skilled in the art would understand that alternative ground compressing members are possible such as a skid. In another embodiment, packer wheel arm 38 and rear link 30 may also be manufactured as a single structural element. In this instance, depth control of packer wheel 42 may be accomplished by having packer wheel 42 attached to packer wheel arm 38 using a vertical slotted plate so that the packer wheel can be raised or lowered by moving it up or down within the slotted plate as needed.

A first dispensing implement 48 for dispensing a first material, such as fertilizer, to a first depth in the ground 2 is mounted to the proximal end 41 of rear link 30. In the embodiment shown in FIG. 1, first dispensing implement 48 is pivotally attached to rear link 30 via trip plate 49 so that when the first implement encounters an obstacle or the ground opener assemblies are being transported, the first dispensing implement will trip, i.e., move backwards so that the first dispensing implement 48 is not damaged. It is understood, however, that first dispensing implement 48 could be fixedly attached to rear link 30 as well. In the illustrated embodiment, the first dispensing implement 48 includes a knife 50 for forming a first furrow in the ground. Immediately behind knife 50, there is tube 52 for depositing a first material, in this case fertilizer, into the first furrow from a supply source (not shown).

A second dispensing implement 54 for dispensing a second material, such as seed, to a second depth preferably different from the first depth is mounted to the distal end 40 of rear link 30. It is understood, however, that the second dispensing implement 54 could include distal end 41 as an integral part thereof and in this instance it would be attached to the rear link at or near pivot point 44. In the illustrated embodiment, the second dispensing implement 54 also includes a knife 56 for forming a second furrow in the ground. Immediately behind knife 56, there is tube 58 for depositing a second material, in this case seed, into the second furrow from a supply source (not shown). While the first and second dispensing implements have been shown with knives, it will be appreciated that other openers for forming a furrow in the ground could also be used, for example, coulters, discs or blades.

A downwardly biasing device, illustrated in FIG. 1 as hydraulic cylinder 60, is attached at a first end to guiding member 18 and at a second end to trip plate 49. However, it is understood that the first end could be attached to the frame directly or by mounting means known in the art and the second end of the hydraulic cylinder could be attached to any rigid part of the opener, for example, directly to rear link 30. The hydraulic cylinder 60 operates to exert a downward bias force on rear link 30 and thus a ground penetrating force to first dispensing implement 48 and second dispensing implement 54. Hydraulic cylinder 60 also exerts a compressing force to packer wheel 42. Hydraulic cylinder 60 is also used to raise the ground opener assembly 10 for transport, which transport position will be described in more detail below. It is understood that other biasing devices such as springs, air bags or the like can also be used.

In operation, guiding member 18 with track 22 allows for greater control and range of motion of ground opener assemblies. This can be more clearly seen in FIGS. 1-3. FIG. 1 shows the ground opener assembly 10 when operating on a fairly flat ground surface. In this scenario, knife 50 and knife 58 have been pre-set at the desired depths of D1 and D2, respectively. The height from the pivot point 28 of second trailing arm 16 to the ground (which reflects the height from the frame to the ground) remains fairly constant at H and first trailing arm 14 rides somewhere in the middle of track 22. It is desirable, however, to maintain the depths D1 and D2 of the knives 50 and 58 consistent through all terrains. This is accomplished due to the ability of the first trailing arm 14 to travel up and down (i.e., the length) of track 22.

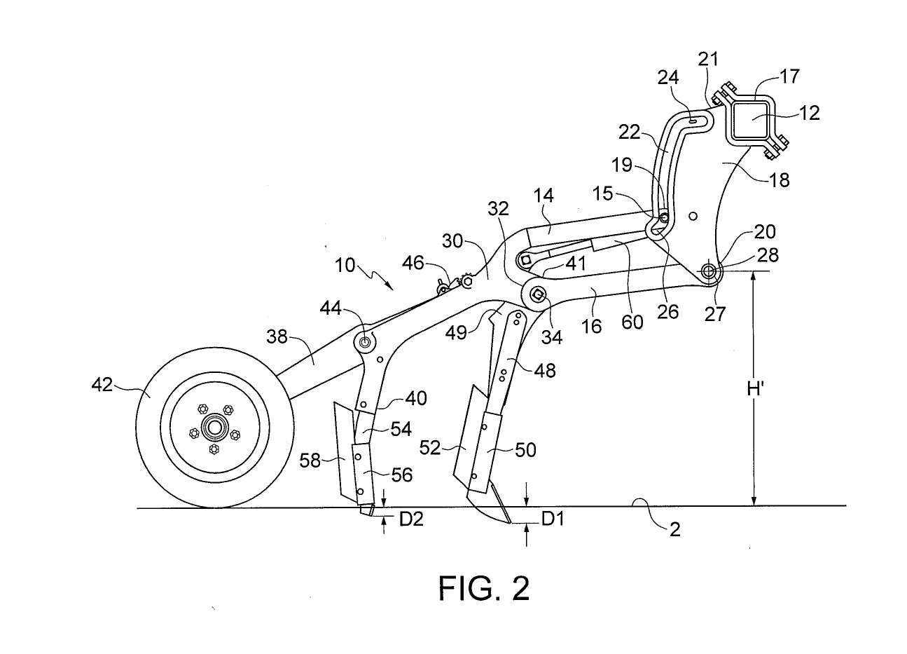

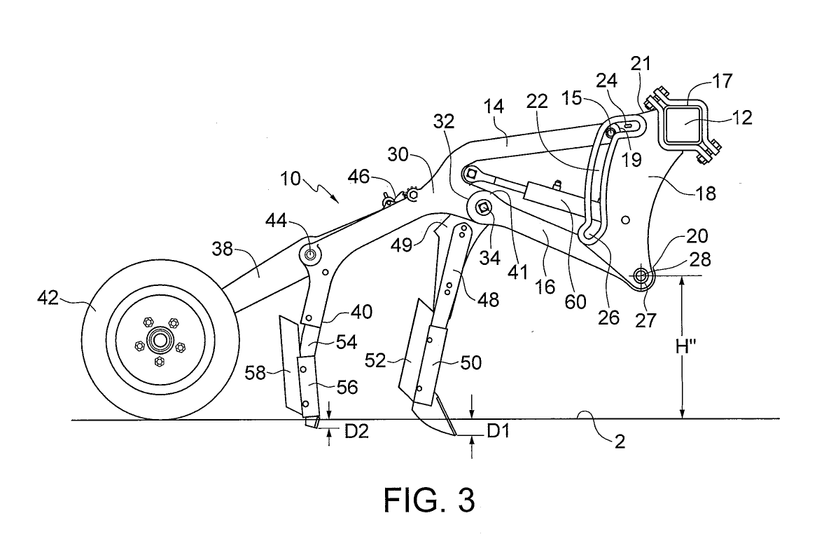

For example, when the ground opener assembly 10 encounters a valley or gully, which situation is shown in FIG. 2, it can be seen that there is a change in the height from the pivot point 28 to the ground from H to H′, which height is now greater than H seen in FIG. 1. Thus, to compensate for this change in height, first trailing arm 14 will be forced to travel downwardly towards the bottom of track 22 so that the depths of knives 50 and 58, D1 and D2, respectively, will still remain the same as that shown in FIG. 1 (i.e., the pre-set depths). On the other hand, when the ground opener assembly 10 encounters a hill, which is shown in FIG. 3, the height is adjusted to H″ (shortened) and as a result the first trailing arm 14 travels towards the top of track 22 to allow the depths of the knives 50 and 58, D1 and D2, respectively, to still remain the same.

In other words, guiding member 18 having track 22 results in the packer wheel 42, seed knife 56 and fertilizer knife 50 remaining spatially consistent and thus the ground opener assemblies can ride up and down in the soil with consistent relationship of these three elements. It is understood that the track itself can be manipulated, i.e., the shape, length, etc. can be customized to provide a full range of motion suitable for any given ground opener assembly.

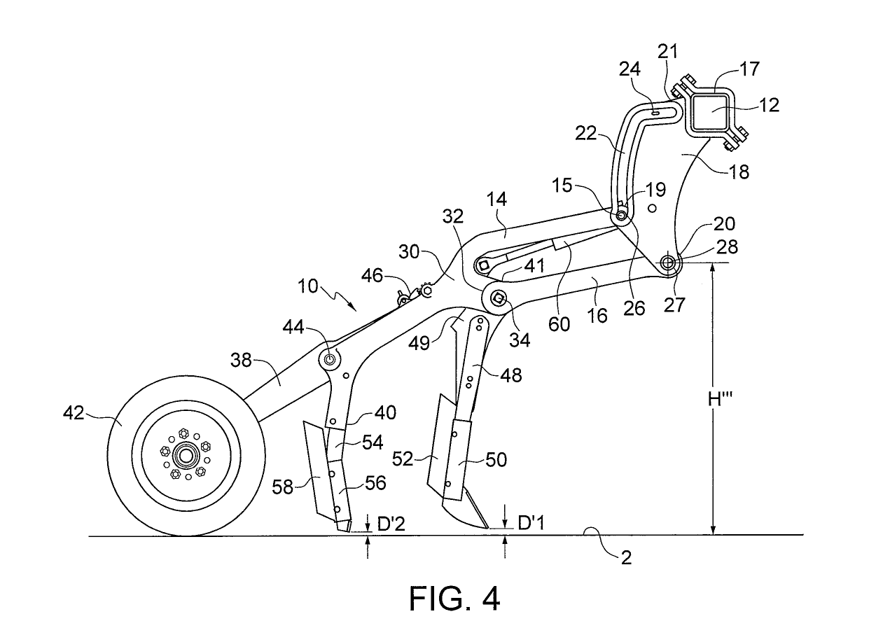

With reference now to FIG. 4, in some instances it may be desirable to have ground opener assembly 10 reach even further (i.e., where H′ is even greater than H′ of FIG. 2) when it encounters a particularly deep gully to attain maximum depth of the packer wheel 42, seed knife 56 and fertilizer knife 50 when seeding in a valley. This can be accomplished by having the track 22 manipulated at the bottom with hook 26 so that first trailing arm 14 can reach down further in track 22 and gain a little bit of stroke without having to necessarily lengthen guiding member 18 and/or track 22. Thus, while the fertilizer and seed knives 50, 58 are not at the desired depths (i.e., D1 and D2, respectively), the distances D′1 and D′2, as shown in FIG. 4, will still allow the knives to at least scratch the surface of the ground 2 and have a great chance to successfully seed and fertilize.

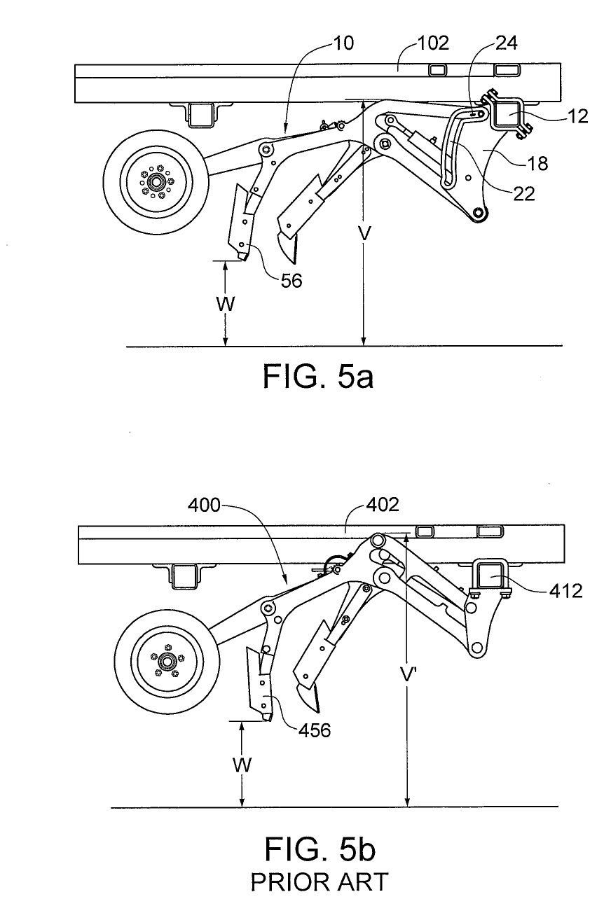

With reference now to FIG. 5a, ground opener assembly 10 is shown in the transport position. In this instance, track 22 is manipulated at the top with hook 24 so that first trailing arm 14 can be lifted to insert into hook 24 to be almost parallel with the frame 12. This allows for maximum ground clearance (shown as clearance from ground to tip of knife 56 of second dispensing implement 54 and labeled “W”). FIG. 5a shows the operation of a trip mechanism on the first dispensing implement 48 so that first dispensing implement 48 is tucked under for better ground clearance. It is important to note that even when the ground opener assembly 10 is lifted well off the ground, the assembly itself does not lift past the frame 12 (i.e., the distance between the top of the assembly and the ground is a maximum distance “V”, which still doesn't interfere with frame 12 or sub-frame 102. Thus, the opener assembly can be tucked away in transport with both good ground clearance and sub-frame 102 clearance.

FIG. 5b, on the other hand, shows a prior art parallel link ground opener assembly 400 in the transport position. It can be seen that in order to have the same clearance distance W from ground to tip of knife 56 of second dispensing implement 54 as in the present invention shown in FIG. 5a, the assembly 400 must form an inverted V-shape which results in part of the assembly being raised above frame 412. In other words, the distance from the top of assembly 400 to the ground is much greater that in the present invention, i.e., V′ versus V. Thus, the assembly 400 will interfere with sub-frame 402. However, if one tries to reduce the distance V′ to V, it is clear that the prior art parallel link ground opener assembly 400 would not achieve the same ground clearance as ground opener assembly 10 of the present invention.

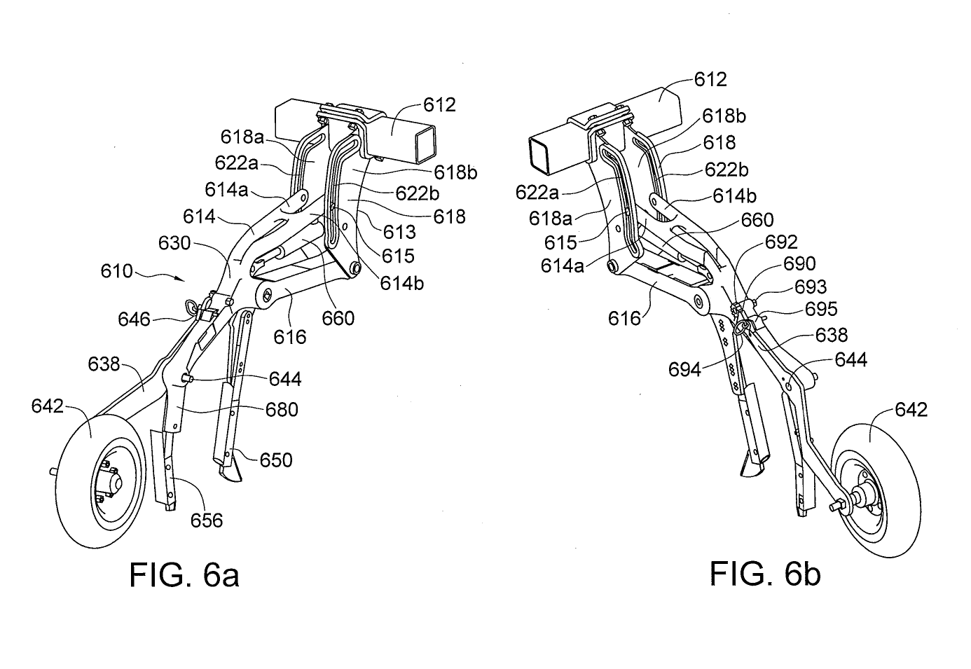

Hence, in use, ground opener assembly 10 having guided track plate 18 with track 22 enjoys the depth control benefits of a parallel link arm assembly versus a single long arm assembly without the drawbacks associated with parallel link arms, such as: ground clearance in transport; frame clearance in transport; and extra wear points, i.e., four pivot points with parallel arms versus two pivot points (second trailing arm only) of ground opener assembly 12. FIG. 6a is a perspective view of the right side of an embodiment of ground opener assembly 610 attached to frame 612. In this embodiment, first trailing arm 614 comprises a pair of spaced, substantially parallel beams 614a and 614b. Each of these parallel beams can be inserted between guiding plate 618a and guiding plate 618b of guiding member 618, each guiding plate 618a and 618b having a track 22a, 22b, respectively, thereon. Parallel beams 614a and 614b are attached to each respective guiding plate by means of a roller 615 that fits within tracks 622a and 622b. This allows first trailing arm 614 to follow along tracks 622a and 622b. Guiding member 618 may further comprise back plate 613 upon which the front end of hydraulic cylinder 660 is attached.

FIG. 6b is a perspective view of the left side of ground opener assembly 610, which shows in more detail the attachment of packer arm 638 to rear link 630 and depth control device 646. As can be seen in FIG. 6b, packer arm 638 is pivotally attached to rear link 630 via pivot 644 near the middle of its length and packer wheel 642 is rotatably attached at its bottom end. Further, the top end of packer arm 638 comprises a plurality of grooves 590, which grooves 690 mesh with sprocket 692. Sprocket 692 can be rotated either clockwise or counterclockwise by adjusting hexagonal shaft 693 with a wrench. Removable pin 694, which is shown inserted through member 695 on packer arm 638 and held into place by a clip on the other side (not shown), is used to set the vertical position of the packer wheel 642 once packer arm 538 has been raised or lowered, depending upon soil conditions, which will subsequently set the depth of the openers.

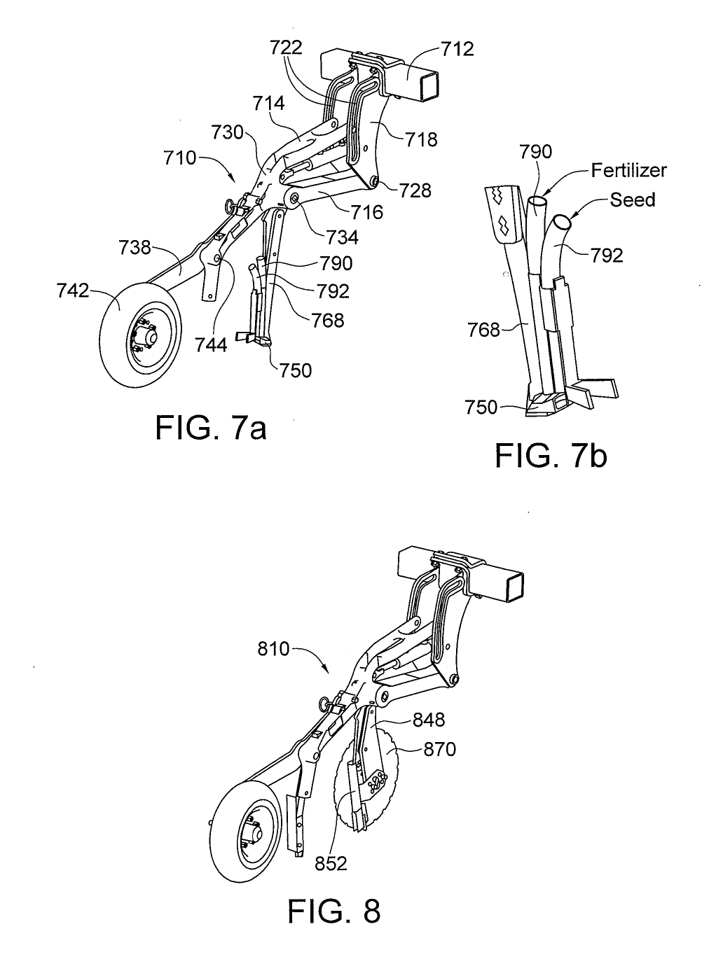

FIG. 7a is a perspective view of the right hand side of an embodiment of a ground opening assembly of the present invention where the ground opener assembly comprises a single ground opener. Ground opener assembly 710 comprises a first trailing arm 714 and a second trailing arm 716, whereby the front ends of each arm are associated with guided track plate 718, which plate is attached to frame 712. Guided track plate 718 comprises an elongated slot or groove, track 722.

First trailing arm 714 is attached to guided track plate 718 such that the first trailing arm 714 can travel or follow the entire length of track 722. Second trailing aim 716, on the other hand, is pivotally attached to the guided track plate 718 by pivot 728. Ground opener assembly 710 further comprises rear link 730. The first trailing arm 714 is fixedly attached to rear link 730 while the second trailing arm 716 is pivotally attached to rear link 730 by pivot 734. It is understood that first trailing arm 714 and rear link 730 may be manufactured as a single structural entity. A packing assembly, comprising packer wheel arm 738 and packer wheel 742, is attached to rear link 730 by pivot 744.

A single dispensing implement 768 for dispensing two (double shoot) materials, such as fertilizer and seed, is mounted to the proximal end of rear link 730, for example, either directly thereto or via a trip plate as previously described. In the illustrated embodiment, the dispensing implement 768 includes a single knife 750, which further comprises two dispensing tubes 790, 792 for dispensing fertilizer and seed, respectively. This can be more clearly seen with reference to FIG. 7b. It is understood, however, that the dispensing implement 768 could also be designed to dispense only one (single shoot) material, such as fertilizer or seed.

FIG. 8 is a perspective view of the right hand side of another embodiment of a ground opening assembly having two dispensing implements where the front dispensing implement 848 comprises a disc 870 having a tube 852 for dispensing a material such as fertilizer.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A ground opener assembly mountable to a frame, comprising:
a guiding member having a track mountable to the frame;
a first trailing arm having a front end and a rear end, the front end of the first trailing arm operably associated with the guiding member so that the first trailing arm can travel along the track;
a second trailing arm having a front end and a rear end, the front end of the second trailing arm pivotally attached to the frame;
a rear link having a proximal end and a distal end, the rear end of the first trailing arm fixedly attached to the proximal end of the rear link and the rear end of the second trailing arm pivotally attached to the proximal end;
at least one dispensing implement and a ground compressing member mounted to the rear link; and
a bias device operative to exert a downward bias force on the rear link, the at least one ground opening tool and the ground compressing member.

2. The ground opener assembly as claimed in claim 1 wherein the first trailing arm and the rear link are a single structural unit.

3. The ground opener assembly as claimed in claim 1 wherein the at least one dispensing implement comprises a knife, a coulter, a disc or a blade.

4. The ground opener assembly as claimed in claim 1 wherein the ground compressing member comprises a packer arm and a packer wheel operably attached thereon.

5. The ground opener assembly as claimed in claim 1 wherein the track is S-shaped.
